(19) United States
(12) Patent Application Publication
(10) Pub. No.: US 2024/0239074 A1
(43) Pub. Date: Jul. 18, 2024

(54) HANDLING OF EMPTY RETURNABLE BEVERAGE CONTAINERS BY MEANS OF A BATTERY-POWERED DEVICE

(71) Applicant: Mr. Fill Holding B.V., CULEMBORG (NL)

(72) Inventors: Jacob Joost LUINSTRA, CULEMBORG (NL); Theo KIK, CULEMBORG (NL)

(73) Assignee: Mr. Fill Holding B.V., CULEMBORG (NL)

(21) Appl. No.: 18/564,775

(22) PCT Filed: May 25, 2022
(86) PCT No.: PCT/EP2022/064319

§ 371 Date: Nov. 28, 2023

(30) Foreign Application Priority Data
May 28, 2021 (NL) 2028332
Jul. 7, 2021 (NL) 2028650

(51) Int. Cl. B30B 9/32; B30B 9/30

(52) U.S. Cl. CPC B30B 9/321; B30B 9/3007; B30B 9/305

(57) ABSTRACT

A receiving and handling mechanism includes: an insert opening; a supply channel for passing the container to a handling device of the mechanism which is driven by a drive and is configured to handle the container; and an outlet. A rechargeable battery powers at least the drive of the handling device. The battery is powered by an external energy source, e.g. a renewable energy source. The method includes: predicting an availability of the external energy source, e.g. a source of solar energy; and adapting the operation of the device based on the predicted energy availability, so as to decrease the energy use of the device in case of a lower predicted energy availability and to increase the energy use of the device in case of a higher predicted energy availability.

### FIELD OF THE INVENTION

The present invention relates to receiving and handling empty returnable beverage containers by means of a battery-powered device configured for receiving and handling returnable empty beverage containers. The device comprises a receiving and handling mechanism, which mechanism comprises:
an insert opening configured to receive an empty beverage container,
a supply channel which extends from the insert opening for passing the received empty beverage container therethrough to a handling device of the mechanism which is driven by a drive and is configured to handle the received container, e.g. the handling device being configured to incise and/or compress the received and handled beverage container, and
an outlet for discharge of the handled beverage container.

A rechargeable battery powers at least the drive of the handling device, wherein the battery is powered by an external energy source.

### BACKGROUND OF THE INVENTION

Battery powered devices for receiving and handling returnable empty beverage containers, in contrast to such type of devices that are permanently connected to an electrical power grid (e.g. reverse vending devices in a supermarket), are favored when no grid connection is present nearby, when making the electrical connection to the grid is cumbersome, and/or when the device is only temporarily deployed at a certain location, e.g. during an event. It is noted that in areas where the electrical power grid is not reliable, and/or not continuously operational, a battery powered device for receiving and handling returnable empty beverage containers can also be deployed with the grid being the external energy source for charging the battery.

A problem associated with such battery powered devices is that the drive consumes a fair amount of energy as each container is handled by the mechanism, e.g. incised and/or compressed. As the battery is powered by an external energy source, the repeated operation of the device may result in that the battery becomes too depleted. For example, when the external energy source is a renewable energy source, e.g. wind and/or sunlight, charging of the battery may fall behind the actual use of energy by the device. This can be remedied, or at least countered to some degree, by having sufficient battery capacity and/or by increasing the capacity of the renewal energy source. Both approaches, however, increase costs of the device. Also, these approaches may lead to increased dimensions of the device, etc.

### OBJECT OF THE INVENTION

The invention aims to provide an effective manner to operate battery powered devices for receiving and handling returnable empty beverage containers.

### SUMMARY OF THE INVENTION

The inventive method comprises:
predicting an availability of the external energy source, e.g. a source of solar energy, and
adapting the operation of the device based on the predicted energy availability, so as to decrease the energy use of the device in case of a lower predicted energy availability and to increase the energy use of the device in case of a higher predicted energy availability.

In appropriate embodiments, the adaptation is done such that the rechargeable battery is prevented from becoming too depleted. The latter may impair the (long-term) functionality of the battery, excessive extent the duration for recharging, and/or undue error messages, etc.

In an embodiment, the device comprises a solar-powered rechargeable battery to power the device, e.g. including an electric motor of the drive of the handling device thereof. The device is provided with a solar panel connected to the battery, e.g. mounted at an exterior of the device. Herein, the external energy source is solar energy captured by the solar panel.

In an embodiment, the step of predicting an availability of the external energy source is based on one or more of:
the actual season,
the actual month of the year,
the actual date,
the GPS-location, e.g. at least the latitude,
climate data,
an actual weather forecast, and
a measured solar irradiation over a certain time period by a sensor of the device.

In an embodiment, adapting the operation of the device based on the predicted energy availability comprises adjusting the number of beverage containers that is still allowed to be inserted, so that the number of containers still allowed to be inserted is lower in case of a lower predicted energy availability and higher in case of a higher predicted energy availability. In simple terms, by way of example, at a certain moment the device is still able to receive another 100 containers, e.g. in a bin under the outlet. However, the predicted energy availability is low so that handling those 100 containers might cause the battery to become too depleted. The method then, in an embodiment, may adapt the operation of the device so that, for example, only 50 more containers are to be handled. For example, once these 50 more containers are handled and the prediction and charging does not improve in the meantime, the device blocks access to the insert opening and indicates to the user that the bin is full. The latter is then not true, but the user will commonly accept this to be the case.

In an embodiment, the number of beverage containers that is still allowed to be inserted is adjusted by controlling a door at the insert opening and/or by controlling the handling of an inserted container by the handling device.

In an embodiment, the number of beverage containers that is still allowed to be inserted is represented by a filling level parameter associated with of a filling level of a bin that is accommodated below the outlet of the mechanism of the device, which filling level parameter is adjusted based on insertion of a container, wherein the method comprises varying the extent by which the filling level parameter is adjusted in dependence of the predicted availability of the external energy source. So, in the exemplary situation outlined above, the filling level parameter would be such that each time a further container was inserted the parameter would be changed to indicate a further 1% reduction of the available space in the bin. However, due to the lower prediction of renewable energy, the method now varies the adjustment of this parameter. For example, instead of 1% the parameter is set to represent a greater, e.g. 2%, reduction of the available space per inserted container. This effectively results, in embodiments, in the determination that the device, e.g. a bin underneath the outlet, is full even when this is not true as only 50 more containers were accepted. Again, the user is expected to accept the message or other indication that the device is full.

In practical embodiments, with a low energy prediction, the method thus may result in the determination that the device or a bin underneath the outlet thereof, is full even when space is still available for containers and would be filled under a high energy prediction. This may result in a staff member having to empty the device or the bin. In extreme cases, when prediction over a long term remains low, the staff member may charge the battery from another source (e.g. a vehicle) quickly or replace the battery for a loaded battery.

In an embodiment, the method comprises:
keeping track of a state of the device and/or of a bin that is accommodated below an outlet of the device, by adjusting a parameter associated with the state and representing the state, the adjusting being based on an operation of the device which involves a change in the state of the device or the bin, said state not involving a state of the battery of the device;
varying the extent by which the parameter associated with the state is adjusted based on an operation of the device, in dependence of the predicted availability of the external energy source for a certain forthcoming time period.

In an embodiment, said at least one state of the device and/or of a bin comprises:
a filling level of the bin, and/or
a number of items that has been inserted or passed a certain point of the device, e.g. a channel or e.g. an outlet of the device, and/or
a received or supplied monetary value to a user, e.g. coins or tokens, or digital credit, and/or
wear of a part of the device, e.g. the handling device, and/or
a cleanliness and/or maintenance status of the device.

For example, the operation of the device that is adapted based on the state(s) comprises one or more of: the number of the containers to still be allowed for insertion, the handling thereof, and/or an indication to an operator that the bin is (almost) full, that the maximum of a certain monetary value has been reached, that the device and/or bin needs maintenance or cleaning, and/or is out of service.

The invention also pertains to a device, which is configured for receiving and handling returnable empty beverage containers. The device comprises a receiving and handling mechanism, which mechanism comprises:
an insert opening configured to receive an empty beverage container,
a supply channel which extends from the insert opening for passing the received empty beverage container therethrough to a handling device of the mechanism which is driven by a drive and is configured to handle the received container, e.g. the handling device being configured to incise and/or compress the received and handled beverage container, and
an outlet for discharge of the handled beverage container,
   which device further comprises a rechargeable battery that is configured to power at least the drive of the handling device, wherein the battery is powered by an external energy source,
   wherein, preferably, the external energy source is a renewable energy source, e.g. solar energy captured by a solar panel mounted at an exterior of the device,
   wherein the device comprises a control unit that is configured to perform a routine that comprises:
predicting an availability of the external energy source, e.g. a source of solar energy, and
adapting the operation of the device based on the predicted energy availability, so as to decrease the energy use of the device in case of a lower predicted energy availability and to increase the energy use of the device in case of a higher predicted energy availability.

Preferably, the device comprises a solar-powered rechargeable battery to power the device, e.g. including an electric motor of the drive of the handling device thereof. The device is provided with a solar panel connected to the battery, e.g. mounted at an exterior of the device. Herein, the external energy source is solar energy captured by the solar panel.

The control unit can be embodied, e.g. programmed, to perform a prediction step to predict an availability of the external energy source based on one or more of:
the actual season,
the actual month of the year,
the actual date,
the GPS-location, e.g. at least the latitude,
climate data,
an actual weather forecast, and
a measured solar irradiation over a certain time period by a sensor of the device.

As explained above, in an embodiment of the device, adapting the operation of the device based on the predicted energy availability comprises adjusting the number of beverage containers that is still allowed to be inserted, so that the number of containers still allowed to be inserted is lower in case of a lower predicted energy availability and higher in case of a higher predicted energy availability.

In practical embodiments, the device is configured such that in use an open topped bin is accommodated below the outlet of the mechanism, which open topped bin is configured to collect the containers therein that are discharged from the outlet, e.g. a wheeled bin.

In embodiments, the device comprises means for detecting the level of beverage containers in the bin, the means including one or more of:
a sensor directed at the inside of the bin for directly measuring the actual level of beverage containers present in the bin, e.g. an acoustic transceiver, an ultrasonic transceiver, an infrared transceiver, a laser transceiver, an inductive sensor, a capacitive sensor or a camera,
a sensor for detecting passing of a beverage container through the handling mechanism, e.g. through the insert opening, through the supply channel, and/or through the outlet of the device, e.g. a light sensor, a movement sensor, or a camera,
a sensor for detecting opening and closing of a door of the device configured for closing off and opening the insert opening, e.g. a magnetic sensor, wherein the sensor is configured to determine the number of times the door has been opened since a predetermined time instant, e.g. a time instant at which the bin has been emptied.

In embodiments, the handling device is configured to compress the received and handled beverage container.

In embodiments, the device has a housing configured to accommodate an open topped bin below the outlet of the mechanism, which bin is configured to collect the beverage containers therein that are received and handled by the receiving and handling mechanism of the device.

For example, the control unit is configured to predict an availability of the external energy source for at least 24 hours, e.g. for multiple days, e.g. for at least a week, e.g. for at least a month, e.g. for three months. For example, in case of solar energy, the control unit may base this prediction on one or more of the actual season, the actual month of the year, the actual date, the GPS-location, e.g. at least the latitude, climate data, an actual weather forecast, and a measured solar irradiation over a certain time period by a sensor of the device. The GPS location and/or other data may e.g. be determined by a sensor of device, be set manually, or retrieved from a server.

The control unit is configured to control the operation of the device, e.g. the drive of the handling device and/or of a door at the insert opening.

The control unit is configured to adapt an operation of the device based on the predicted energy availability, such as to adapt the energy use of the device to the energy availability.

For example, the control unit may be configured to limit the number of beverage containers that is still allowed to be inserted in the bin, e.g. by controlling the door at the insert opening, and/or the handling of an inserted container by the handling device, dependent on the available energy availability. The number of containers still allowed to be inserted is lower in case of a lower predicted energy availability, and higher in case of a higher predicted energy availability. Thereby, advantageously, the energy use may be reduced in case of lower predicted energy availability, which may lead to the battery being discharged less in case it is expected to be charged to a lesser extent by the external energy source in the near future. Advantageously, no measurement of the battery charge is involved at all in this process, while still a battery discharge is saved in anticipation on a lower energy availability for recharging it.

In an embodiment, the control unit has implemented therein, as is common, an algorithm which is configured to keep track of at least one state of the device and/or bin,
a filling level of the bin, and/or
a number of items that has been inserted or passed a certain point of the device, e.g. a channel or e.g. an outlet of the device, and/or
a received or supplied monetary value to a user, e.g. coins or tokens, or digital credit, and/or
wear of a part of the device, e.g. the handling device and/or
a cleanliness and/or maintenance status of the device.

The operation of the device that is adapted based on the state(s), may for example be the number of the containers to still be allowed for insertion, the handling thereof, and/or an indication to an operator that the bin is (almost) full, that the maximum of a certain monetary value has been reached, that the device and/or bin needs maintenance or cleaning, and/or is out of service.

The control unit may be configured to manipulate the registered state in order to manipulate the operation, and thereby, the energy use of the device, e.g. in a way previously discussed. Thus, the control unit makes use of this already existing part of its programming. The manipulation involves adjusting an parameter, associated with the state of the device and/or bin and representing the state, based on an operation of the device which involves a change in the state of the device or the bin that is accommodated below the outlet. For example, such operation may be the detection of the receipt of a beverage container through the insert opening, or the passing of the container through the supply channel and/or outlet, the handling of the container by the handling device, or an input of a user via a user interface. Such operation involves a state change of the device, for example a change in the filling level of the bin, namely an increase thereof. Notably, the state does not involve a state of the battery of the device, but another state, of which examples have been given before.

The control unit may be configured to adjust the parameter associated with the state of the device, e.g. the filling level of the bin, based on the operation—for example, to adjust the parameter associated with the filling level upwards upon a detected passing of a beverage container through the outlet. For example, the control unit is in this embodiment configured to vary the extent by which the parameter associated with the state of the device is adjusted upon a certain operation in dependence of the predicted availability of the external energy source for a certain forthcoming time period. For example, the extent is decreased in case of a high predicted availability, and is increased in case of a low predicted availability. This enables that in case of a low predicted availability, the bin is registered by the control unit as becoming more filled for the same number of inserted beverage containers.

The control unit may be configured to adapt an operation of the device based on a parameter associated with the state of the device to adapt the energy use of the device to the state. For example, if the parameter relates to the filling level of the bin, the control unit may be configured to limit the number of beverage containers that is still allowed to be inserted in the bin, e.g. by controlling the door at the insert opening, and/or the handling of an inserted container by the handling device, dependent on the filling level.

For example, in case of a low predicted energy availability, the value of the parameter relating to the filling level is higher with a lower number of containers being inserted, because the extent by which it is adjusted upon each container insertion is set higher. In effect, less containers may be allowed into the bin, e.g. the door may be controlled to open a lower number of times, than when the filling level is still low or medium. The fact that less containers are allowed into the device, makes that the device has to receive and handle less beverage containers, and less energy is used by the device to receive and handle beverage containers. Therefore, the withdrawal of battery capacity is decreased, and the battery capacity is saved without involving any measurement on the battery capacity. In case of a high predicted energy availability, the extent of adjustment of the filling level parameter may be set lower again, so that a larger number of containers may be received and handled by the device before the filling level is registered as high, so that the battery capacity is not saved. Thus, a device is obtained which dynamically adjusts its operation to a predicted energy availability to save battery life, and thus anticipates on the energy availability, without measuring the actual available battery capacity.

The present invention also relates to a method for receiving and handling empty returnable beverage containers by means of a battery-powered device configured for receiving and handling returnable empty beverage containers, which device comprises a mechanism configured to incise and/or compress the inserted beverage container having a drive powered by a rechargeable battery, wherein the battery is powered by a solar panel of the device, e.g. mounted at an exterior of the device, wherein the method comprises:
predicting an availability of solar energy,
adjusting the number of beverage containers that is still allowed to be inserted, so that the number of containers still allowed to be inserted is lower in case of a lower predicted energy availability and higher in case of a higher predicted energy availability.

The present invention also relates to a device for receiving and handling empty returnable beverage containers, which device comprises a mechanism configured to incise and/or compress an inserted beverage container having a drive powered by a rechargeable battery of the device, wherein the battery is powered by a solar panel of the device, e.g. mounted at an exterior of the device, and wherein the device comprises a control unit that is configured to perform a routine that comprises:
predicting an availability of solar energy,
adjusting the number of beverage containers that is still allowed to be inserted, so that the number of containers still allowed to be inserted is lower in case of a lower predicted energy availability and higher in case of a higher predicted energy availability.

The invention furthermore relates to a system comprising a device and a bin as described. For example, the system may further comprise an outer frame on which the device is supported, and a space underneath the device for the bin to be placed.

### BRIEF DESCRIPTION OF THE DRAWINGS

The invention will now be described with reference to the appended drawings. In the drawings:

FIGS. 1, 2 show, schematically, a first embodiment of the system according to the invention with a plunger in the initial upper position,

FIG. 3 shows the same embodiment with the plunger being about to move downwards towards an inserted and beverage container in a handling position,

FIG. 4 shows the same embodiment with the plunger engaging the container,

FIGS. 5, 6, 7 show the same embodiment with the plunger moving downwards through the cutting range,

FIG. 8 shows the same embodiment with the plunger in the lower, pressing position,

FIG. 9 shows the same embodiment with the plunger moving upwards back towards the raised initial position,

FIG. 10 shows the same embodiment with the plunger back in the raised initial position,

FIG. 11 shows schematically, top views of possible lateral cross-sections of the main channel above the plunger,

FIG. 12 shows an embodiment with the plunger in the pressing position,

FIG. 13 shows schematically another embodiment of the system according to the invention,

FIG. 14 shows schematically a possible arrangement of sensors and electrical units in the system,

FIG. 15 shows schematically the interconnection between the sensors and electrical units,

FIG. 16 shows schematically an embodiment of a system according to the invention in a perspective view,

FIGS. 17, 18 show, in perspective view a second embodiment of the system according to the invention with a pivoting container engaging body in the initial upper position,

FIGS. 19, 20 show, in a side view the same embodiment with the pivoting container engaging body in the initial upper position,

FIGS. 21-25 show, in a side view, the same embodiment with the progression of the pivoting container engaging body moving from the upper initial position to the pressing position,

FIG. 26 illustrates, in a side view, the handling of a container by the pivoting body.

### DETAILED DESCRIPTION OF EMBODIMENTS

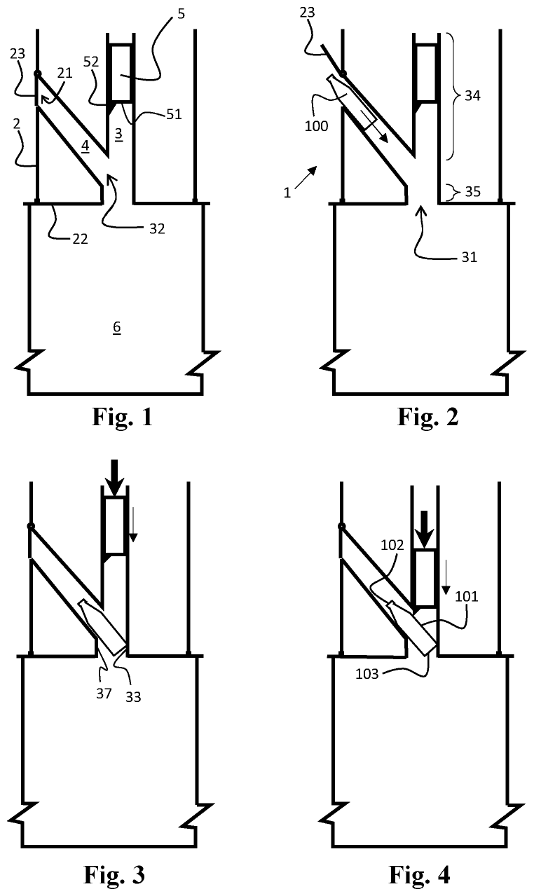

The FIGS. 1-11 depict a first possible embodiment of the system according to the invention.

The system comprises an open topped bin 6 and a device 1 for receiving and handling empty returnable beverage containers according to the invention, see FIG. 1.

The device 1 is configured for receiving and handling returnable empty beverage containers 100. Such a beverage container generally has a circumferential side wall 101 and opposed longitudinal ends 102,103, indicated in FIG. 4. In embodiments, the device 1 is configured for handling cans and plastic bottles.

The device 1 comprises a receiving and handling mechanism, which mechanism comprises:
an insert opening 21 configured to receive an empty beverage container,
a supply channel 4 which extends from the insert opening 21 for passing the received empty beverage container 100 therethrough to a handling device 5 of the mechanism which is driven by a drive 85 and is configured to handle the received container; and
an outlet 31 for discharge of the handled beverage container 100 into the bin 6.

The device 1 further comprises a rechargeable battery 84 that is configured to power at least the drive 85 of the handling device, wherein the battery is powered by an external energy source 82.

Here, as preferred, the external energy source is a renewable energy source. It is shown that the source is solar energy that is captured by a solar panel 82 mounted at an exterior of the housing 2 of the device 1.

The device 1 comprises a control unit 9 that is configured to perform a routine that comprises:
predicting an availability of the external energy source, e.g. a source of solar energy, and
adapting the operation of the device based on the predicted energy availability, so as to decrease the energy use of the device in case of a lower predicted energy availability and to increase the energy use of the device in case of a higher predicted energy availability.

The device comprises the housing 2 with the insert opening 21 configured to receive an empty beverage container 100.

In FIG. 2, the device 1 is shown while receiving an empty beverage container 100 through the insert opening 21. The device has a door 23 for closing the insert opening 21, as in FIG. 1. The door is opened for clearing the insert opening 21 so that the container 100 may pass through it.

A main channel 3 runs substantially vertically and defines at a lower end thereof outlet 31 of the device, see FIGS. 1 and 2. A supply channel 4 defines the insert opening 21 and ends in a lateral opening 32 in the main channel 3, so as to end in the main channel 3. The supply channel 4 has a slanted downwards orientation in the direction from the insert opening 32 towards the lateral opening 32. The supply channel 4 is configured to pass the empty beverage container 100 therethrough from the insert opening 21 into the main channel 3, thus advancing from FIG. 2 to FIG. 3.

The main channel 3 is dimensioned such that a distance between the lateral opening 32 and a portion of the main channel wall 33 that is opposite to the lateral opening, in the direction of the orientation of the supply channel 4, is shorter than a predetermined minimum length of the empty beverage containers 100 to be received and handled by the device, such that one of such beverage containers, after having passed from the insert opening 21 through the supply channel 4, is still supported by the supply channel 4 with a rearward one of the longitudinal ends 102 thereof still inside the supply channel 4, while it extends through the lateral opening 32 into the main channel 3 with the other, forward one of the longitudinal ends 103 thereof, with this second longitudinal end 103 resting against said wall portion of the main channel 3, see FIGS. 3 and 4.

The bin 6 of the system has a top opening, above which the device 1 is supported by a support element 22 of the device 1. The support element 22 is in the form of a horizontal plate 22 which is placed on the top side of the bin 6. The horizontal plate 22 has an opening that adjoins the outlet 31 of the device, and is within the contour of the top opening of the bin 6 when the device is supported thereon, so that beverage containers passing through the outlet 31 fall into the bin 6. The horizontal plate 22 supports the housing 2 of the device 1 thereon. FIG. 16 shows an embodiment of the system in a perspective view to clarify the spatial arrangement. Of the device, a downstream part of the main channel 3 and supply channel 4 are shown, as well as the plate 22.

Here the bin 6 is an open-topped wheeled bin, e.g. a 240 liter wheeled bin, and the plate 22 extends over the open top of the bin 6 so as to form a temporary lid for the bin 6. There is an outer frame inside which the device and the bin are placed.

As shown the bin 6 may have a hinged lid, that is opened (folded along a side of the bin), before the bin is placed in the housing.

The bin 6 may be of plastic material, as is known in the art.

The device 1 further comprises a drive and a container engaging body 5, which is embodies as a plunger 5 having, at a bottom surface 51 thereof, a cutting element 52 in the form of a vertical knife element that extends, seen from above, substantially perpendicular to the longitudinal direction of the supply channel 4—see for example FIG. 11 which shows top views of possible cross-sections right above the plunger 5.

The supply channel here longitudinally extends from the left to the right, and the knife element extends perpendicularly thereto. In other embodiments the cutting element may also be a vertical puncturing element.

The plunger 5 is shown in an initial upper position in FIG. 1. In this position, its bottom surface 51 and cutting element 52 is higher than the lateral opening 32. In FIG. 2, the door 23 is opened and an empty beverage container 100 is being inserted by a user (not shown) through the insert opening. In FIG. 3, the beverage container 100 has passed under the influence of gravity through the supply channel 4 and through the lateral opening 32, and is supported by the supply channel 4 and against the portion of the main channel wall 33 diametrically opposed to the lateral opening 32.

The drive for the plunger 5, may be embodied as a piston that is fixed to the top of the plunger 5, which piston moves over a vertical spindle above the plunger, which spindle is connected to an electromotor. Alternatively, an overpressure may be applied above the plunger 5 by a corresponding drive, inside a telescopic pneumatic cylinder fixed relative to the main channel 3, of which cylinder the piston end is connected to the plunger 5. Such arrangements are in the FIGS. 1-11 simplified to an arrow indicating the downward force exerted by the cylinder on the plunger 5. Because of the downward force by the pneumatic cylinder, the plunger 5 is in FIG. 3 about to move downwards through the main channel 3 towards the container 100.

In this embodiment, the main channel is formed by a closed vertical surface which encloses the plunger 5, in particular with a substantially circular, oval, square or rectangular cross-section. The plunger snugly fits into the main channel.

Advancing from FIG. 3 to FIG. 4, plunger 5 has under the downwards force of the cylinder vertically moved from the initial position to a position in which its cutting element 52 engages the side wall 101 of the supported beverage container 100 for cutting the side wall 101 in between the longitudinal ends 102,103.

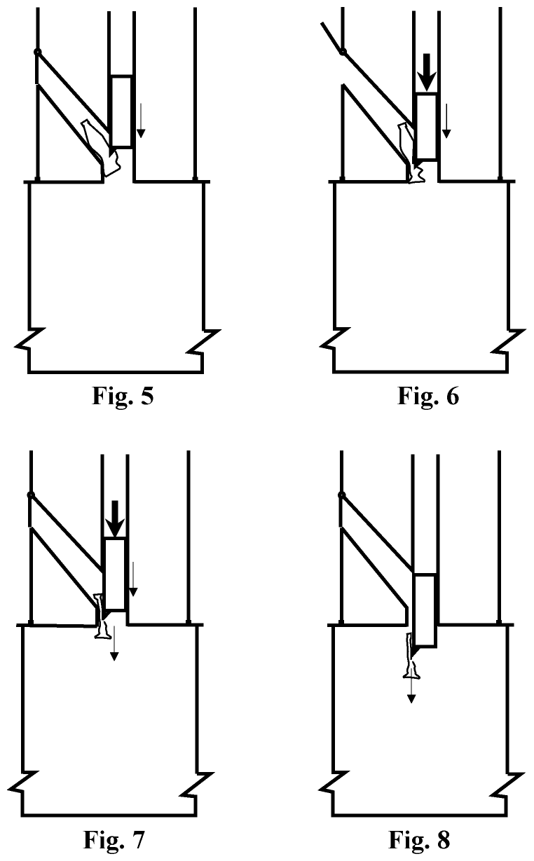

In FIG. 5, the plunger 5 has moved further downward into a cutting range. It has already made an incision in the side wall 101 of the container 100, and the downwards movement of the container pushes the side wall 101 on the downstream side of the incision downwards, and has thereby already slightly compressed the downstream part longitudinally.

In FIG. 6, the downward movement has progressed a little bit further, and the pushing of the cutting element against the container wall part underneath the cut has caused the container to rotate around the bottom edge of the lateral opening 32 towards a more upright position. Now the container starts being compressed laterally as well in a compression space 36 that is in between an outer front wall 53 of the plunger 5 and a wall portion 37 of the main channel 3 directly below the lateral opening 32. This compression space 36 is indicated in the top views of FIG. 11. The compression space 36 extends vertically from the lateral opening 32 to the outlet, and horizontally along the entire lateral opening 32. The compression space 36 is created by letting a lower section 35 of the main channel 3 below the lateral opening 32 have a larger cross-section, than the plunger 5. An upper section 34 of the main channel has a cross-section which corresponds to that of the plunger 5, so that the outer front wall 53 of the plunger 5 lies against the main channel wall 33 in this upper section 34. The sections 45,35 are indicated in FIG. 2. Referring again to FIGS. 6 and 11, a dimension of the horizontal cross-section of the compression space 36 between the wall portion 37 of the main channel 3 below the lateral opening 31 and the front wall 53 of the plunger 5 is smaller than the cross-section of the supply channel 4. The distance s indicated in FIG. 11 is here about 0.5-2 cm, namely around 1 cm. An upstream section of the beverage container 100 is dragged, during the movement of the plunger 5 from the cutting position to the lower position, from the lateral opening through the compression space to the outlet 36. For containers 100 having a certain cross-section, including the shown container, this involves compression of the container in the compression space 36 between the main channel wall 33 and the front wall 53 of the plunger 5, while the plunger 5 moves further downward from the cutting range to a lower position with the bottom surface 51 of the plunger 5 below the lateral opening 32.

Another possibility to provide the compression space 36 is to, instead of or in addition to the larger dimension of the main channel lower section 35 relative to the upper section 34, have the plunger 5 have a cross-section smaller than both the upper and the lower section. If the plunger 5 is moved by varying a gas pressure above it, the plunger 5 may at a top section be provided with guides 53 that guide the plunger 5 in its vertical motion through the main channel 3 against the wall thereof.

In FIG. 7, the lateral compression of the container 100 has been continued by the further downwards movement of the plunger 5 which pulls the container 100 further into the compression space 36. In FIG. 8, the plunger 5 has moved into a lower position in which the bottom surface 51 of the plunger 5 is even further below the lateral opening 32, namely below the outlet 31, so that the container 100 has passed through the compression space 36 completely, through the outlet 31, and is cleared from the plunger 5 so as to fall in the bin 6.

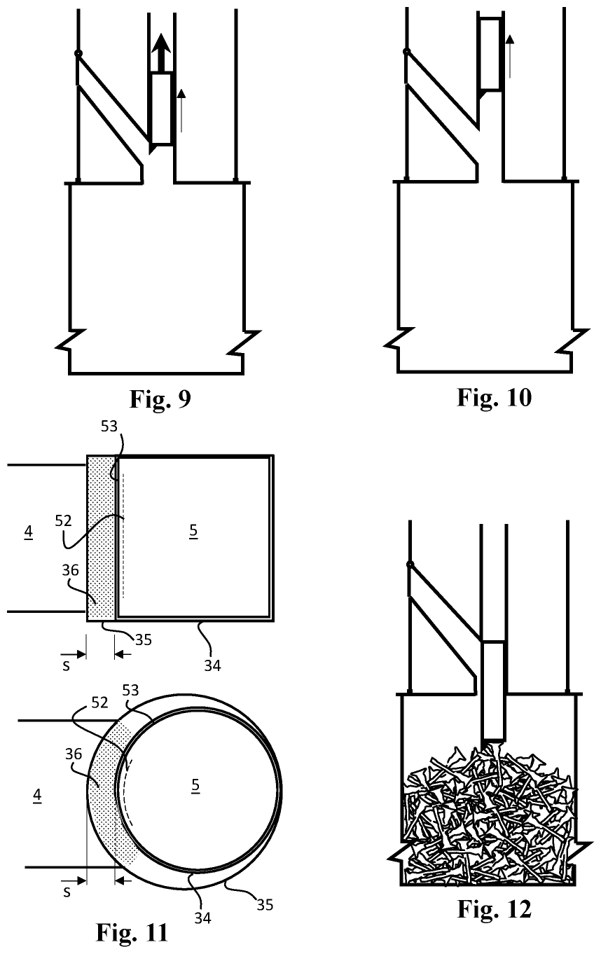

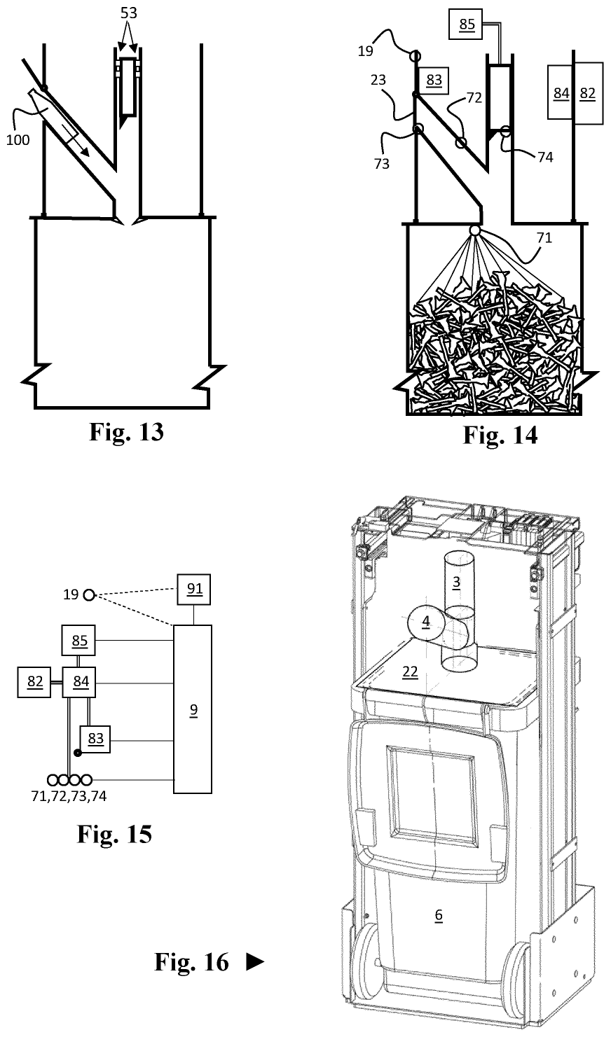

Thereafter, as shown in FIG. 9, an upwards force is applied by the drive above the plunger 5. This is indicated by the upwardly directed arrow. As a consequence the plunger 5 moves upwardly from the lower position back to the raised initial position shown in FIG. 10.

It is shown in FIG. 12, that the plunger 5 may furthermore be vertically movable through the main channel 3 into a pressing position, e.g. after the lower position, in which the bottom surface 51 of the plunger 5 extends even further below the outlet 31 and inside the bin 6. In this position, when a certain level of stored containers in the bin has been reached, the plunger compresses the stored containers so as to decrease their volumes even further. It is noted that the lower position shown in FIG. 8 can here also be considered as a pressing position, because it would press on the stored containers whenever the filling level would be a higher, namely corresponding to the height of the bottom surface 51 of the plunger 5 in this lower position.

Note that the height of the plunger 5 is such that, in all positions of the plunger 5, at least top section of the plunger 5 is in the upper section 34 of the main channel 3. In this way, the outer side surface 53 of the plunger 5 remains abutted to the inner wall of the main channel 3 in the upper section 34. Its top surface is in none of the positions below within the contour of the lateral opening 32, or within the lower section 35. Thus the plunger 5 substantially blocks access from the supply channel 4 to the main channel 3 via the lateral opening 32 in the positions of FIGS. 4-8 and 12. In FIGS. 4-7, the access is blocked by the container 100 and the plunger 5 barricading the lateral opening 32. Via the compression space 36, e.g. in FIG. 8 showing the lower position, access to the main channel 3 is nearly impossible as well for a user given the dimension s of 1 cm, see FIG. 11.

The cutting element 52 is provided at or near a circumference of the bottom surface 51 of the plunger 5 at a tangential location that adjoins the lateral opening 32 in the cutting position of the plunger 5—see FIG. 4. The cutting element 52, in this cutting position of the plunger 5, substantially extends in at least a horizontally central portion of the horizontal extension of the lateral opening 32, see FIG. 11.

A cross-section of the supply channel 4 is dimensioned such as to correspond to predetermined maximum lateral dimensions of the beverage containers 100 to be inserted. A diameter of the supply channel corresponds to a maximum diameter of the beverage containers to be inserted.

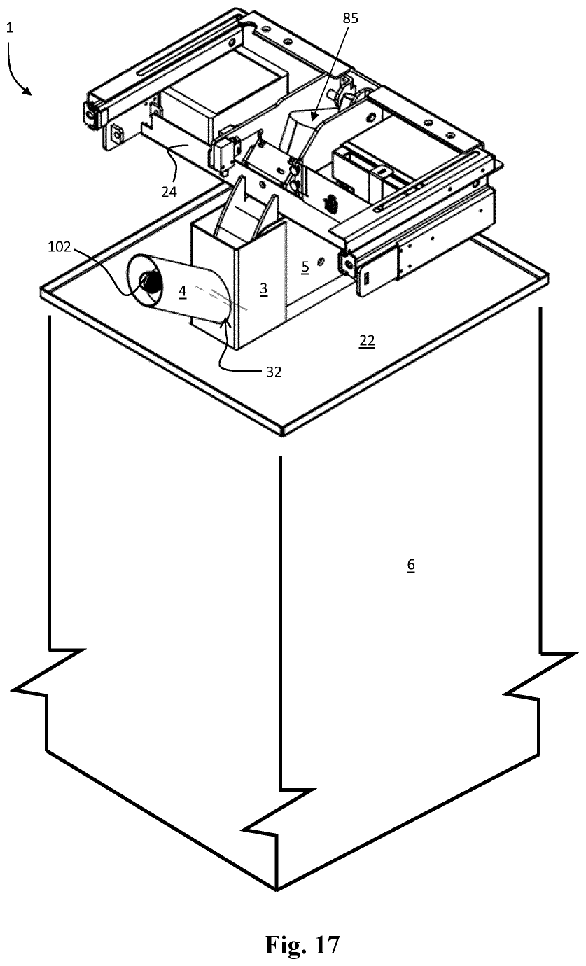

Now referring to FIGS. 14 and 15, it is shown that the control unit 9 is in communication with the drive 85 and is configured to control the drive 85 to move plunger 5.

For example, the control includes controlling the force exerted by the drive 85 on the plunger 5 for driving the bottom surface 51 of the plunger 5 against the container 100 being handled and/or against the stored containers in the lower and/or pressing position, wherein the force is higher when respectively the container 100 gives more resistance against the plunger, and/or when the height of a level of the beverage containers in the bin 6 is higher.

The control unit 9 is communication with the drive 85 and is configured to control the drive 85 to move plunger 5, e.g. based on or triggered by a level of beverage containers in the bin 6.

The control unit 9 is configured to perform a routine that comprises:
predicting an availability of the external energy source 82, here a source of solar energy, and
adapting the operation of the device 1, based on the predicted energy availability, so as to decrease the energy use of the device in case of a lower predicted energy availability and to increase the energy use of the device in case of a higher predicted energy availability.

In particularly practical embodiments, the energy use of the drive 84 is adapted as in practical embodiments that is the largest energy consumer in the device 1. However, the adaptation of the operation may, also or alternatively, involve one or more other energy users in the device.

In a simple embodiment, for example, when the expected availability is low, the plunger 5 can be moved less to save energy, for example the movement towards the pressing position in FIG. 12 may be omitted.

The energy source of the drive 85 is the solar-powered battery 84 of the device 1 which also powers the sensors 71,72,73,74, see FIG. 15.

The housing 2 of the device 1 is provided with one or more photovoltaic panels 82 for capturing solar irradiation, see FIG. 14, and these panels 82 are connected via a transformer to the battery 84, see FIG. 15.

The control unit 9 is configured to adapt the operation of the drive 85 based on an availability of solar energy predicted thereby for a certain forthcoming time period.

The prediction can be done by the control unit 9 and is, for example, based on one or more of the actual season, the actual month of the year, the actual date, an actual weather forecast, e.g. for one or more days, for which the data may be obtained via a server 91 in communication with the control unit 9, and and/or solar irradiation over a certain time period, registered as being received by the panels 82 and/or as measured by a sensor of the device 1.

For example, the control unit 9 is configured to, in case of a low predicted availability of solar energy for a certain forthcoming time period, control the drive 85 to move the plunger 5 to the pressing position less frequent than in case of a low predicted availability of solar energy for a certain forthcoming time period, e.g. relative to a detected level of beverage containers in the bin 6 by means of one or more sensors 71,72,73,74 for detecting the level of beverage containers in the bin 6.

For example, in areas with a moderate latitude, during winter, the solar irradiation can be expected to be less than in summer as the number of daylight hours per day is less. The control unit 9 may be configured to set the device to an energy saving mode during the winter period. This may include to move the plunger 5 to the pressing position less or less frequent during winter months, or e.g. already during fall, because a lower availability of solar energy during the forthcoming months can be expected.

The expected solar irradiation can be expected to be less in areas where less sun hours are expected per day, for example in areas with a high latitude, than in areas where more sun hours are expected, for example areas with moderate latitude. In the same line of thought, climate data may be used to make anticipations on the operation of the device. In an example, GPS data or manually provided data may be used to make predictions on the expected solar irradiation and the associated availability of energy in the near future.

FIG. 14 shows an example with sensors 71,72,73,74. FIG. 15, which schematically shows the interconnection between the electric units of the device 1, shows that these sensors are in communication with the control unit 9. Sensor 71 is a laser transceiver that is directed at the inside of the bin 6 for directly measuring the actual level of beverage containers present in the bin 6—some laser beams have been indicated to illustrate the principle. Multiple measurements are taken along a range of angles from the sensor to obtain an accurate indication of the filling level over the whole range of the bin. Sensor 72 is a movement sensor for detecting passing of a beverage container through the supply channel 4. Sensor 73 is a magnetic sensor for detecting opening and closing of the door 23. The control unit 9 is configured to determine the number of times has been opened since the bin 6 has been emptied. Sensor 74 is a load cell for detecting the force of the plunger 5 against the beverage containers in the bin 6 in order to move to the pressing position. A higher force indicates more or stiffer beverage containers being present in the bin 6. The control unit 9 is configured to, based on the detected level of beverage containers by these means, control the drive to move the plunger 5 to the pressing position only when the detected level of beverage containers is above a predetermined level that is indicated in FIG. 14. Below this level, the plunger 5 cannot reach the containers in the bin 6 and moving it to the pressing position would therefore be a waste of energy.

In an embodiment, the control unit 9 is configured, e.g. programmed, such that the adaptation of the operation of the device 1 based on the predicted energy availability comprises adjusting the number of beverage containers 100 that is still allowed to be inserted, so that the number of containers still allowed to be inserted is lower in case of a lower predicted energy availability and higher in case of a higher predicted energy availability. This can be done, for example, by controlling the door at the insert opening 21.

In an embodiment, the number of beverage containers 100 that is still allowed to be inserted via opening 21 is represented by a filling level parameter associated with of a filling level of the bin 6 that is accommodated below the outlet 31 of the mechanism of the device 1. This filling level parameter is adjusted based on insertion of a container 100. The routine performed by the control unit 9 comprises varying the extent by which the filling level parameter is adjusted in dependence of the predicted availability of the external energy source. For example, in case of a low predicted energy availability, the value of the parameter relating to the filling level is higher with a lower number of containers being inserted, because the extent by which it is adjusted upon each container insertion is set higher. In effect, less containers may be allowed into the bin, e.g. the door may be controlled to open a lower number of times, than when the filling level is still low or medium. The fact that less containers are allowed into the device, makes that the device has to receive and handle less beverage containers, and less energy is used by the device to receive and handle beverage containers. Therefore, the withdrawal of battery capacity is decreased, and the battery capacity is saved without involving any measurement on the battery capacity. In case of a high predicted energy availability, the extent of adjustment of the filling level parameter may be set lower again, so that a larger number of containers may be received and handled by the device before the filling level is registered as high, so that the battery capacity is not saved. Thus, a device is obtained which dynamically adjusts its operation to a predicted energy availability to save battery life, and thus anticipates on the energy availability, without measuring the actual available battery capacity.

The device further comprises a sensor for detecting the position and/or speed of the plunger 5 over time.

For safety reasons, the control unit 9 is configured to control the drive 85 to move plunger 5 to the cutting, releasing, and pressing position only when the housing 2 is detected by a sensor of the device to be closed for access by a user from outside the device, i.e. when the door 23 for closing off the insert opening 21 is closed.

The control by the control unit 9 is adjustable via server 91 by authorized persons, e.g. the municipality and/or the refuse collection service.

In the embodiment of FIG. 14, the door 83 is controlled by the electronically controlled door mechanism 83 which is powered by the solar battery 84, see FIG. 15. The control unit 9 controls it to be opened only if it is determined that an authorized user identified himself and/or paid a fee, as determined at a server 91. The user may thereto identify himself or herself by means of identifier 19 on the housing. For example, via a card readable by the identifier 19, or a mobile device. For example via NFC and/or RFID and/or Bluetooth and/or WLAN technology. The identifier 19 may be connected to the control unit 9 and/or to the server 91, e.g. via a wireless internet connection, see the dashed lines in FIG. 15. The control unit and/or the server 91 may determine, e.g. based on the payment of a fee, and/or based on an identification of the user in a digital database, whether or not to grant access to the device 1. If access is granted, the door mechanics 83 may be controlled by the control unit 9 to open the door 23.

Or, the identifier 19 may not be connected thereto at all, as it is in the form of a code scannable by a mobile device of the user, e.g. a mobile device, e.g. a smartphone. The identifier may therein be a QR-code which is unique for the specific device 1. After scanning the code, the mobile device may connect to the server 91, sending to the server 91 data associated with the device 1 and data associated with the user, may determine, e.g. based on the payment of a fee, and/or based on an identification of the user in a digital database, whether or not to grant access to the device 1, and send a corresponding command to the control unit 9. If access is granted, the door mechanics 83 may be controlled by the control unit 9 to open the door 23.

The control unit 9 denies access to the device also in case of a certain determined filling level: namely if the bin 6 is completely full and the last detected force exerted by the plunger on the containers 100 in the pressing position exceeded a certain level. The control unit 9 also denies access to the device in case the battery 84 is charged only below a certain level, i.e. just enough to power the door mechanics 83 and the control unit 9.

The control unit 9 has, or is connected to, a memory in which the sensor values are logged. By analysis of these values, valuable information can be derived on the contents of the bin and on the operation of the device. Such information may be made available to operators—for example information may be sent actively to operators in case of any malfunctioning or an anomalous state.

For example, the detected values of the position of the plunger 5, the force exerted thereby while handling an inserted item, and the elapsed time are indicative of the effort that has been necessary to handle a particular item. When an item made of a material that is not, or hardly, compressible by the plunger 5 has been handled by the device, the detected force may be notably high, the number of cycles of the plunger may be higher than usual, even as the time needed to handle the item before it moves into the container. Or, a blockage of the plunger 5 may be detected. For example, the control unit 9 may be programmed to initiate an alarm signal in this case. In the log, operators may check for indications of any malfunctioning. A low detected force combined with a detected passage of a beverage container through the outlet 31 may indicate a beverage container which did not require compression, or required only slight compression. A detected passage of a beverage container through the outlet 31 without any movement of the plunger 5 may indicate that the beverage container was smaller than the cross-section of the main channel 3 below the lateral opening 32, so that it did not come into the handling position at all, and passed without compression through the main channel 3 and into the bin.

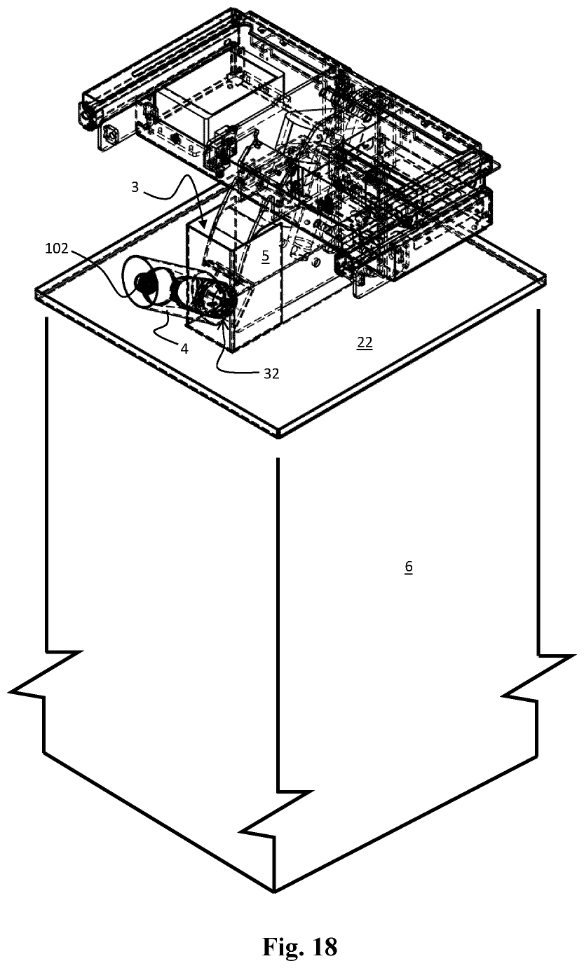

FIGS. 17-26 depict a second embodiment of the system according to the invention, wherein the same parts are denoted by the same reference number as in the first embodiment. The FIGS. 17-26 show the system right after a plastic PET-bottle 100 of 0.5 L has been inserted into the supply channel 4 via the insert opening 21. The container engaging body 5 is still in the initial upper position thereof.

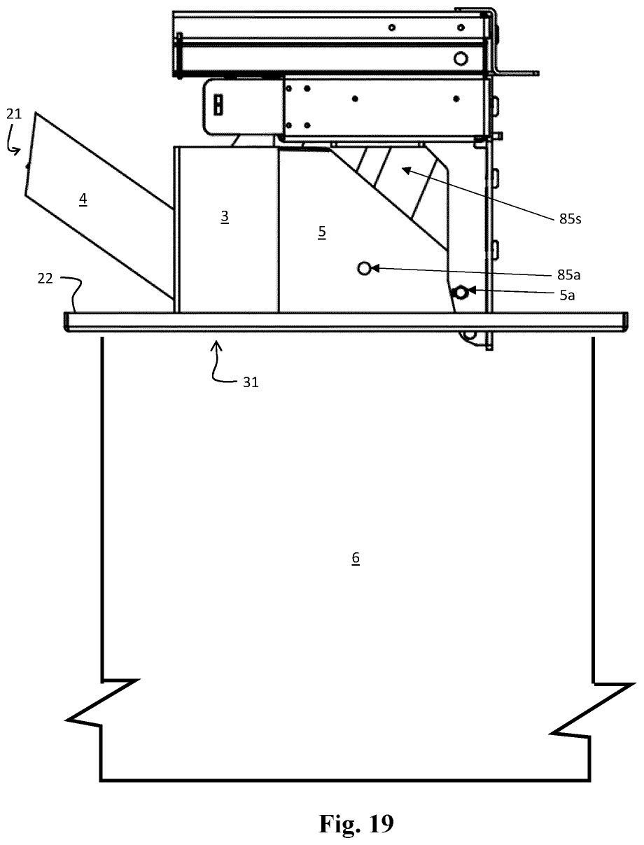

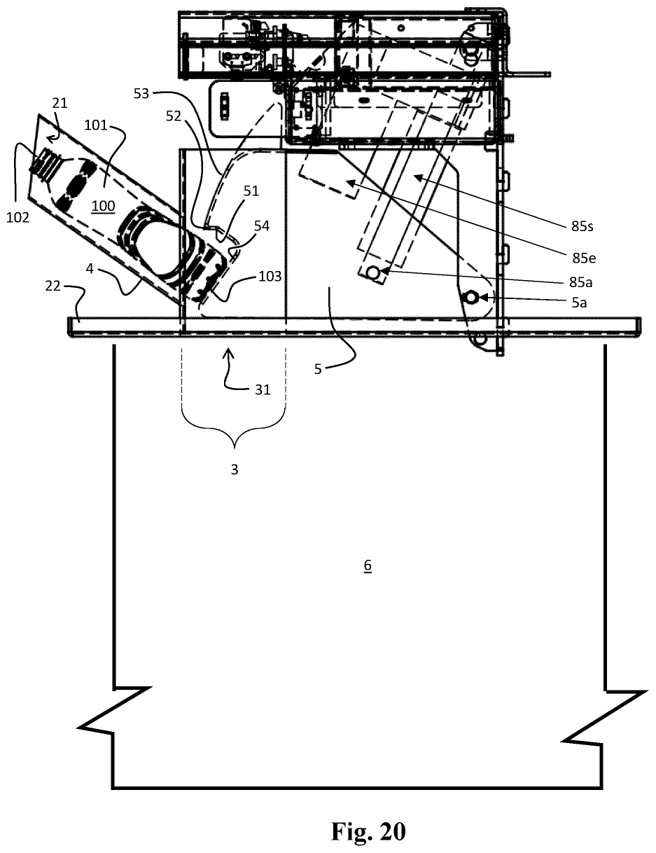

In this embodiment, the container engaging body 5 is not a plunger, as in the first embodiment, but a pivoting body 5 which is substantially wedge-shaped when viewed from the side, see FIGS. 19-20. Also, in this embodiment, other than in the first embodiment, the wall portion facing the lateral opening 32 is not a wall portion of the main channel 3, but a wall portion 54 of the wedge-shaped pivoting body 5, see in particular FIG. 20. This wall portion 54 is part of an indent of the front wall 53 of the pivoting body 5 towards the horizontal pivot axis 5a, which also has the surface 51 with the cutting element 52. It is noted, that such indent is also applicable in the first embodiment.

The main channel 3 is open at the rear side, the side and front walls forming substantially a U-shape when viewed in a horizontal cross-section. There is thus no rear wall, so that the wedge-shaped pivoting body 5 moves only with a front section thereof inside the main channel 3 for handling the bottle 100. A rear section of the pivoting body 5 is located outside the main channel 3. The pivot axis 5a runs parallel to the lateral opening 32 and perpendicular to the direction of the supply channel.

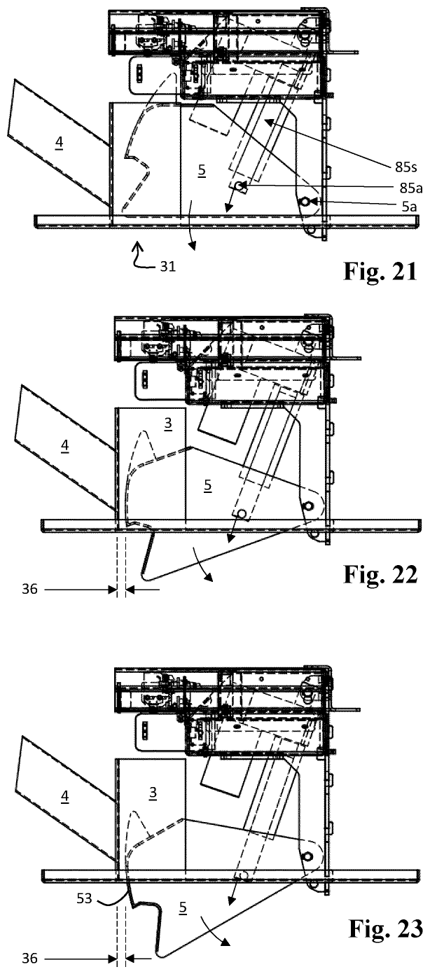

In the figures depicting the second embodiment, the drive 85 is indeed shown. It has an electromotor 84e, which is via a transmission connected to the spindle 85s. The piston of the spindle is pivotally connected to the pivoting body 5 at a horizontal distance between the pivot axis 5a thereof, via a drive pivot axis 85a. By this configuration, the drive can pivot the pivoting body downwards through the cutting range and to the lower position and further to a pressing position. The progression of this pivoting movement is shown in FIGS. 21-25, showing the device 1 according to the second embodiment.

Upon pivoting downwards from the initial upper position shown in FIG. 21, the cutting element moves downwards to engage the side wall 101 at some distance of the frontmost longitudinal end 103 of the bottle 100. The longitudinal end 103, which forms the very stiff, laterally hardly compressible basis of the bottle, rotates slightly forward (that is, counterclockwise in the view of FIG. 20) and ends up sideways between the wall portion 54 and the main channel wall portion 37 directly below the lateral opening as the pivoting body 5 moves through the cutting range. Because of the engagement below the surface 51, the stiff base advantageously does not need lateral compression to be moved downwards towards the outlet 31. This saves energy given the amount of force which would be required for such compression, as discussed before.

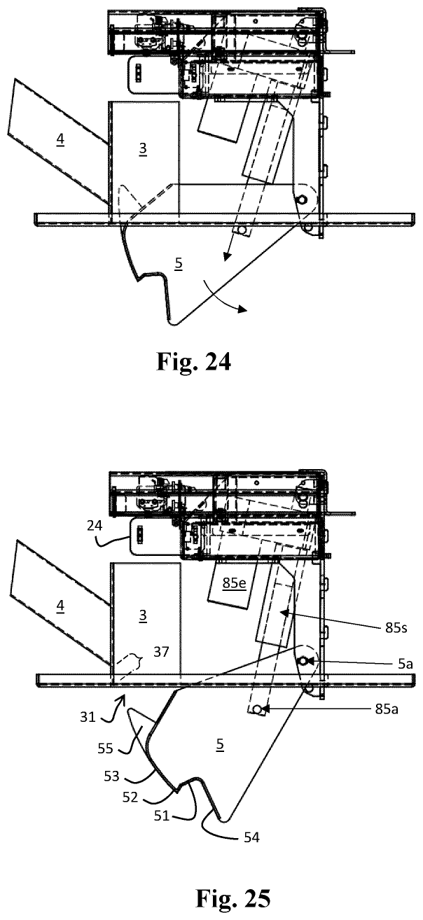

As the pivoting body 5 pivots further from the cutting range towards the lower position illustrated in FIG. 24, the bottle 100 is dragged with a longitudinally central section thereof in the compression space 36 formed between the front wall 53 and the main channel wall portion directly below the lateral opening 32, where it is compressed laterally. The rounded shape of the front wall 53 of the wedge, makes that after incising the container while moving through the cutting range, a lateral compression of the bottle 100 between the front wall 53 and the main channel front wall portion directly underneath the lateral opening, takes place in a compression space that substantially remains the same size as the pivoting body pivots towards the lower position, since the distance between this main channel front wall portion and the front wall 53 of the pivoting body remains substantially the same. Thus, the bottle 100 can be compressed by substantially the same amount along the length of its side wall 101.

After the compression of the central section, the neck of the bottle 100, which forms the rearward longitudinal end 102, is passed between the front wall 53 of the container engaging element 5 and the wall portion 37 uncompressed, because of the shape of the front wall 53 being such, that the compression ends right below the neck of the bottle at the rearward end 102 thereof. This is advantageous because the neck of the bottle 100 is also stiff and hardly compressible in the lateral direction. To this end, the curvature of the rounded front wall progressively increases onwards from a distance above the cutting element which corresponds to the length of the longitudinally central section of the bottle 100. This is done such that the distance between the wall portion 37 and the front wall 53 is increased enough to fit the neck of the bottle 100 as soon as this part of the front wall 53 faces the wall portion 37. In the lower position of the pivoting body, the bottle 100 is released into the bin 6 through the outlet 31.

FIG. 25 shows the pressing position of the container engaging body, in which it is pivoted approximately 10-20 degrees beyond the lower position. Even though the container engaging body 5, because of its shape, already extends with its bottom side below the plate 22 and into the bin 6 as soon as it pivots downwards from the initial upper position, the pressing position enables an even larger vertical reach of the container engaging body 5—and thus a lower filling level of incised containers in the bin 6 at which the container engaging body 5 may start to compact the containers in the bin 6.

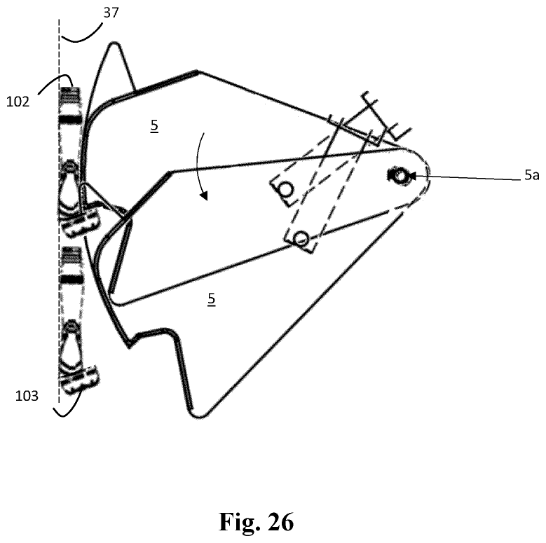

FIG. 26 illustrates the container engaging body 5 both in the position of FIG. 22 when moving from the cutting range towards the lower position, and of FIG. 24 in the lower position.

The 0.5 L PET-bottle 100 is shown after the incision is made above the base of the bottle 100 this part still being uncompressed. The center section of the bottle 100 is in the shown position of FIG. 22 being compressed in the compression space 36, between the front wall 53 and the wall portion 37. It can be verified that the center section of the side wall 101 of the bottle 100 is forced to assume a smaller lateral cross-section, corresponding to the compression space 36. Furthermore, the bottle 100 is shown while the container engaging element is in the lower position of FIG. 24, thus while the part of the front wall 53 with the increased curvature faces the wall portion 37 and realizes a larger horizontal distance between the wall portion 37 and the container engaging element 5. It can be verified that this enables that the neck of the bottle 100 can pass unhindered and uncompressed, and through the outlet 31.

As best shown in FIG. 17 and indicated in FIG. 25, the pivoting body 5 comprises side plates which form upper flanges 55 at the tangential end of the wedge that is remote from the cutting element 52. These flanges are positioned against a front plate 24 of the housing 2 when the pivoting body is in the initial upper position. Sensors, operationally connected to the control unit 9, are positioned between the flanges to check if the pivoting body is in the initial upper position thereof.

The control unit 9, sensors, solar panels, and other features of the first embodiment, shown in FIG. 15, may be applied similarly to the second embodiment. Furthermore, the configuration shown in FIG. 16 with the plate 22 covering a wheeled bin 6, may be applied equally. Other features of the first embodiment may also be applied in the second embodiment and vice versa. For example, the plunger 5 of the first embodiment may equally be provided with an indent forming the surfaces 51 and 53 as in the second embodiment, and/or equally be provided with a drive shown in the second embodiment.

1. A method for receiving and handling empty returnable beverage containers by means of a battery-powered device configured for receiving and handling returnable empty beverage containers, the device comprising a receiving and handling mechanism, the receiving and handling mechanism comprising:
an insert opening configured to receive an empty beverage container;
a supply channel extending from the insert opening for passing the received empty beverage container therethrough to a handling device of the receiving and handling mechanism, the handling device being driven by a drive and being configured to handle the received container; and
an outlet for discharge of the handled beverage container,
wherein a rechargeable battery powers at least the drive of the handling device, wherein the battery is powered by an external energy source,
wherein the method comprises:
predicting an availability of the external energy source; and
adapting the operation of the device based on the predicted energy availability, so as to decrease energy use of the device in case of a lower predicted energy availability and to increase the energy use of the device in case of a higher predicted energy availability.

2. The method according to claim 1, wherein the device comprises a solar-powered rechargeable battery to power the device, wherein the device is provided with a solar panel connected to the battery, and wherein the external energy source is solar energy captured by the solar panel.

3. The method according to claim 1, wherein the predicting of an availability of the external energy source is based on one or more of:
the actual season;
the actual month of the year;
the actual date;
the GPS-location;
climate data;
an actual weather forecast; and
a measured solar irradiation over a certain time period by a sensor of the device.

4. The method according to claim 1, wherein adapting the operation of the device based on the predicted energy availability comprises adjusting the number of beverage containers that is still allowed to be inserted, so that the number of containers still allowed to be inserted is lower in case of a lower predicted energy availability and higher in case of a higher predicted energy availability.

5. The method according to claim 4, wherein the number of beverage containers that is still allowed to be inserted is adjusted by controlling a door at the insert opening and/or by controlling the handling of an inserted container by the handling device.

6. The method according to claim 4, wherein the number of beverage containers that is still allowed to be inserted is represented by a filling level parameter associated with of a filling level of a bin that is accommodated below the outlet of the mechanism of the device, the filling level parameter being adjusted based on insertion of a container, and wherein the method comprises varying the extent by which the filling level parameter is adjusted in dependence of the predicted availability of the external energy source.

7. The method according to claim 1, wherein the method comprises:
keeping track of a state of the device and/or of a bin that is accommodated below an outlet of the device, by adjusting a parameter associated with the state and representing the state, the adjusting being based on an operation of the device which involves a change in the state of the device or the bin, said state not involving a state of the battery of the device; and
varying the extent by which the parameter associated with the state is adjusted based on an operation of the device, in dependence of the predicted availability of the external energy source for a certain forthcoming time period.

8. The method according to claim 7, wherein said at least one state of the device and/or of a bin comprises:
a filling level of the bin and/or
a number of items that has been inserted or passed a certain point of the device; and/or
a received or supplied monetary value to a user or digital credit; and/or
wear of a part of the device; and/or
a cleanliness and/or maintenance status of the device.

9. The method according to claim 8, wherein the operation of the device that is adapted based on the state(s) comprises one or more of: the number of the containers to still be allowed for insertion, the handling thereof, and/or an indication to an operator that the bin is full, that the maximum of a certain monetary value has been reached, that the device and/or bin needs maintenance or cleaning, and/or is out of service.

10. The method according to claim 1, wherein an open topped bin is accommodated below the outlet of the mechanism, open topped bin being configured to collect the containers therein that are discharged from the outlet, and wherein the device comprises means for detecting the level of beverage containers in the bin, the means including one or more of:
a sensor directed at the inside of the bin for directly measuring the actual level of beverage containers present in the bin;
a sensor for detecting passing of a beverage container through the handling mechanism; and
a sensor for detecting opening and closing of a door of the device configured for closing off and opening the insert opening, wherein the sensor is configured to determine the number of times the door has been opened since a predetermined time instant.

11. The method according to claim 1, wherein the handling device is configured to compress the received and handled beverage container.

12. The method according to claim 1, wherein the device has a housing configured to accommodate an open topped bin below the outlet of the mechanism, bin being configured to collect the beverage containers therein that are received and handled by the receiving and handling mechanism of the device.

13. A device for receiving and handling empty returnable beverage containers, the device comprising:
a receiving and handling mechanism, the receiving and handling mechanism comprising:
an insert opening configured to receive an empty beverage container;
a supply channel extending from the insert opening for passing the received empty beverage container therethrough to a handling device of the receiving and handling mechanism, the handling device being driven by a drive and being configured to handle the received container; and
an outlet for discharge of the handled beverage container;
a rechargeable battery that is configured to power at least the drive of the handling device, wherein the battery is powered by an external energy source, source; and
a controller configured to perform a routine that comprises:
predicting an availability of the external energy source; and
adapting the operation of the device based on the predicted energy availability, so as to decrease the energy use of the device in case of a lower predicted energy availability and to increase the energy use of the device in case of a higher predicted energy availability.

14. The device according to claim 13, wherein the device comprises a solar-powered rechargeable battery to power the device, wherein the device is provided with a solar panel connected to the battery, and wherein the external energy source is solar energy captured by the solar panel.

15. The device according to claim 13, wherein the predicting of an availability of the external energy source is based on one or more of:
the actual season;
the actual month of the year;
the actual date, date;
the GPS-location;
climate data;
an actual weather forecase; and
a measured solar irradiation over a certain time period by a sensor of the device.

16. The device according to claim 13, wherein adapting the operation of the device based on the predicted energy availability comprises adjusting the number of beverage containers that is still allowed to be inserted, so that the number of containers still allowed to be inserted is lower in case of a lower predicted energy availability and higher in case of a higher predicted energy availability.

17. The device according to claim 16, wherein the number of beverage containers that is still allowed to be inserted is adjusted by controlling a door at the insert opening and/or by controlling the handling of an inserted container by the handling device.

18. The device according to claim 16, wherein the number of beverage containers that is still allowed to be inserted is represented by a filling level parameter associated with of a filling level of a bin that is accommodated below the outlet of the mechanism of the device, the filling level parameter being adjusted based on insertion of a container, and wherein the controller is configured to vary the extent by which the filling level parameter is adjusted in dependence of the predicted availability of the external energy source.

19. The device according to claim 13, wherein the routine comprises:
keeping track of a state of the device and/or of a bin that is accommodated below an outlet of the device, by adjusting a parameter associated with the state and representing the state, the adjusting being based on an operation of the device which involves a change in the state of the device or the bin, said state not involving a state of the battery of the device; and
varying the extent by which the parameter associated with the state is adjusted based on an operation of the device, in dependence of the predicted availability of the external energy source for a certain forthcoming time period.

20. The device according to claim 19, wherein said at least one state of the device and/or of a bin comprises:
a filling level of the bin; and/or
a number of items that has been inserted or passed a certain point of the device; and/or
a received or supplied monetary value to a user, e.g. coins or tokens, user or digital credit; and/or
wear of a part of the device; and/or
a cleanliness and/or maintenance status of the device.

21. The device according to claim 20, wherein the operation of the device that is adapted based on the state(s) comprises one or more of: the number of the containers to still be allowed for insertion, the handling thereof, and/or an indication to an operator that the bin is full, that the maximum of a certain monetary value has been reached, that the device and/or bin needs maintenance or cleaning, and/or is out of service.

22. The device according to claim 13, wherein the device is configured such that in use an open topped bin is accommodated below the outlet of the mechanism, the open topped bin being configured to collect the containers therein that are discharged from the outlet, and wherein the device comprises means for detecting the level of beverage containers in the bin, the means including one or more of:
a sensor directed at the inside of the bin for directly measuring the actual level of beverage containers present in the bin;
a sensor for detecting passing of a beverage container through the handling mechanism, and/or through the outlet of the device; and
a sensor for detecting opening and closing of a door of the device configured for closing off and opening the insert opening, wherein the sensor is configured to determine the number of times the door has been opened since a predetermined time instant.

23. The device according to claim 13, wherein the handling device is configured to compress the received and handled beverage container.

24. The device according to claim 13, wherein the device has a housing configured to accommodate an open topped bin below the outlet of the mechanism, the bin being configured to collect the beverage containers therein that are received and handled by the receiving and handling mechanism of the device.

25. A method for receiving and handling empty returnable beverage containers by means of a battery-powered device configured for receiving and handling returnable empty beverage containers, device comprising a mechanism configured to incise and/or compress the inserted beverage container having a drive powered by a rechargeable battery, wherein the battery is powered by a solar panel of the device, wherein the method comprises:
predicting an availability of solar energy; and
adjusting the number of beverage containers that is still allowed to be inserted, so that the number of containers still allowed to be inserted is lower in case of a lower predicted energy availability and higher in case of a higher predicted energy availability.

26. A device for receiving and handling empty returnable beverage containers, the device comprising a mechanism configured to incise and/or compress an inserted beverage container having a drive powered by a rechargeable battery of the device, wherein the battery is powered by a solar panel of the device, and wherein the device comprises a controller configured to perform a routine that comprises:
predicting an availability of solar energy; and
adjusting the number of beverage containers that is still allowed to be inserted, so that the number of containers still allowed to be inserted is lower in case of a lower predicted energy availability and higher in case of a higher predicted energy availability.
